(19) United States
(12) Patent Application Publication
(10) Pub. No.: US 2011/0080318 A1
(43) Pub. Date: Apr. 7, 2011

(54) Determining A Dilution of Precision Metric Using Two or Three GPS Satellites

(75) Inventors: Farshid ALIZADEH-SHABDIZ, Wayland, MA (US); Mohammad HEIDARI, Worcester, MA (US)

(73) Assignee: SKYHOOK WIRELESS, INC., Boston, MA (US)

(21) Appl. No.: 12/572,516

(22) Filed: Oct. 2, 2009

(51) Int. Cl. G01S 19/48

(52) U.S. Cl. 342/357.31

(57) ABSTRACT

The disclosed subject matter relates to a method for determining a Dilution of Precision Metric (DOP) with less than four satellites in a hybrid positioning system. In some embodiments, the method includes determining an initial position estimate of a device using a non-satellite positioning system, obtaining satellite measurements from less than four satellites, wherein the measurements include each satellite's position with respect to the initial position estimate, constructing a geometry matrix corresponding to the measurements from the less than four satellites using each satellite's position and the initial position estimate, multiplying the geometry matrix by its transpose to construct an H matrix, determining an inverse of the H matrix, and determining the DOP based on a sum of the diagonal elements of the inverse H matrix. In some embodiments, the non-satellite positioning system is a WLAN positioning system.

### CROSS-REFERENCE TO RELATED APPLICATIONS

This application is related to the following references:

U.S. patent application Ser. No. 12/479,721, filed Jun. 5, 2009 and entitled “Systems and methods for Using Environmental Information in a Hybrid Positioning System;”

U.S. patent application Ser. No. 12/479,722, filed Jun. 5, 2009 and entitled “Systems and Methods for Maintaining Clock Bias Accuracy in a Hybrid Positioning System;”

U.S. patent application Ser. No. 12/479,723, filed Jun. 5, 2009 and entitled “System and Method for Refining a WLAN-PS Estimated Location Using Satellite Measurements in a Hybrid Positioning System;”

U.S. patent application Ser. No. 12/479,724, filed Jun. 5, 2009 and entitled “Systems and Methods for Determining Position Using a WLAN-PS Estimated Position as an Initial Position in a Hybrid Positioning System;”

U.S. patent application Ser. No. 12/479,727, filed Jun. 5, 2009 and entitled “Methods and Systems for Improving the Accuracy of Expected Error Estimation in a Hybrid Positioning System;”

U.S. patent application Ser. No. 12/479,729, filed Jun. 5, 2009 and entitled “Methods and Systems for Stationary User Detection in a Hybrid Positioning System;”

U.S. patent application Ser. No. 12/479,734, filed Jun. 5, 2009 and entitled “System and Method for Using a Satellite Positioning System to Filter WLAN Access Points in a Hybrid Positioning System;”

U.S. patent application Ser. No. 12/479,718, filed Jun. 5, 2009 and entitled “Method and System for Determining Location Using a Hybrid Satellite and WLAN Positioning System by Selecting the Best WLAN-PS Solution;”

U.S. patent application Ser. No. 12/485,588, filed Jun. 16, 2009 and entitled “Methods and Systems for Determining Location Using a Cellular and WLAN Positioning System by Selecting the Best WLAN PS Solution;”

U.S. patent application Ser. No. 12/485,591, filed Jun. 16, 2009 and entitled “Methods and Systems for Determining Location Using a Cellular and WLAN Positioning System by Selecting the Best Cellular Positioning System Solution;”

U.S. patent application Ser. No. 12/485,595, filed Jun. 16, 2009 and entitled “Methods and Systems for Improving the Accuracy of Expected Error Estimation in Location Determinations Using a Hybrid Cellular and WLAN Positioning System;”

U.S. patent application Ser. No. 12/504,373, filed Jul. 16, 2009 and entitled “Systems and Methods for Using a Satellite Positioning System to Detect Moved WLAN Access Points;”

U.S. patent application Ser. No. 12/504,379, filed Jul. 16, 2009 and entitled “Methods and Systems for Determining Location Using a Hybrid Satellite and WLAN Positioning System by Selecting the Best SPS Measurements;”

U.S. patent application Ser. No. 12/569,106, filed Sep. 29, 2009 and entitled “Improvement of the Accuracy and Performance of the Hybrid Positioning System;” and

U.S. patent application Ser. No. (TBA), filed concurrently herewith and entitled “A Method of Determining Position in a Hybrid Positioning System Using a Dilution of Precision Metric.”

### BACKGROUND

1. Field

The present disclosure generally relates to hybrid positioning systems and more specifically, the assessment of the quality of a set of visible satellites to be used in a positioning system.

2. Description of Related Art

Positioning using radio signals has attracted increasing attention in the field of location and tracking The initial research studies on satellite positioning systems (SPS) resulted in a very accurate Global Positioning System (GPS) which was initially used for military applications and later broadly used for commercial and personal applications. The availability of SPS-based positioning has been a major factor in the introduction of Location Based Services (LBS) in advanced mobile communication devices such as smartphones. By determining the position of the receiver, the system is able to provide more effective and more appropriate services to the user.

The Naystar Global Positioning System (GPS) operated by the US Government leverages about two-dozen orbiting satellites in medium-earth orbits as reference points. A user equipped with a GPS receiver can estimate his three-dimensional position (latitude, longitude, and altitude) anywhere at any time within several meters of the true location as long as the receiver can see enough of the sky to have four or more satellites “in view.” Cellular carriers can use signals originating from and received at cell towers to determine a user's or a mobile device's location. Assisted GPS (AGPS) is another model that combines both GPS and cellular tower techniques to estimate the locations of mobile users who may be indoors and must cope with attenuation of GPS signals on account of sky blockage. In this model, the cellular network attempts to help a GPS receiver improve its signal reception by transmitting information about the satellite positions, their clock offsets, a precise estimate of the current time, and a rough location of the user based on the location of cell towers. No distinction is made in what follows between GPS and AGPS.

All positioning systems using satellites as reference points are referred to herein as Satellite-based Positioning System (SPS). While GPS is the only operational SPS at this writing, other systems are under development or in planning A Russian system called GLONASS and a European system called Galileo may become operational in the next few years. All such systems are referred to herein as SPS. GPS, GLONASS and Galileo are all based on the same basic idea of trilateration, i.e., estimating a position on the basis of measurements of ranges to the satellites whose positions are known. In each case, the satellites transmit the values of certain parameters which allow the receiver to compute the satellite position at a specific instant. The ranges to satellites from a receiver are measured in terms of the transit times of the signals. These range measurements can contain a common bias due to the lack of synchronization between the satellite and receiver (user device) clocks, and are referred to as pseudoranges. The lack of synchronization between the satellite clock and the receiver (user device) clock can result in a difference between the receiver clock and the satellite clock, which is referred to as internal SPS receiver clock bias or receiver clock bias, here. In order to estimate a three dimensional position there is a need for four satellites to estimate receiver clock bias along with three dimensional measurements. Additional measurements from each satellite correspond to pseudorange rates in the form of Doppler frequency. References below to raw SPS measurements are intended generally to mean pseudoranges and Doppler frequency measurements. References to SPS data are intended generally to mean data broadcast by the satellites. References to an SPS equation are intended to mean a mathematical equation relating the measurements and data from a satellite to the position and velocity of an SPS receiver.

WLAN-based positioning is a technology which uses WLAN access points to determine the location of mobile users. Metro-wide WLAN-based positioning systems have been explored by several research labs. The most important research efforts in this area have been conducted by the PlaceLab (www.placelab.com, a project sponsored by Microsoft and Intel); the University of California, San Diego ActiveCampus project (ActiveCampus—Sustaining Educational Communities through Mobile Technology, technical report #CS2002-0714); and the MIT campus-wide location system. There is only one commercial metropolitan WLAN-based positioning system in the market at the time of this writing, and it is referred to herein as the WPS (WiFi positioning system) product of Skyhook Wireless, Inc (www.skyhookwireless.com).

SPS is based on triangulation (trilateration) using multiple distance measurements from multiple satellites. The receiver measures its distance from at least four satellites. Based on the distance measurements, the receiver solves a set of quadratic equations including (xᵣ,yᵣ,zᵣ), coordinates of the receiver, and τᵣ, receiver clock bias. In order to quantify the accuracy of the location estimate (quality of estimate of the reported location,) SPS systems use several metrics such as Dilution of Precision (DOP₀) (Indices, like index 0, are used to differentiate different DOP definitions here). Widely used in literature, the geometry of the set of visible satellites, indicated by DOP₀ metric, is assumed to have correlation with estimated location error. In other words, DOP₀ relates the geometry of the satellites to the quality of the location estimate.

Different DOP₀ metrics and values, such as Horizontal Dilution of Precision (HDOP) or Position Dilution of Precision (PDOP)), have been used in the last two decades to decide on the quality of a set of satellites used for positioning. A set of satellites can be considered for positioning if its resulted DOP₀ metric is below a threshold. Note that DOP₀ metric can be measured differently with different scales, but its importance is to provide a means to assess the quality of the set of visible satellites.

For example, if all the satellites are exactly above the location of the receiver or very close to one another that set of satellites cannot be used for positioning. Geometrically, satellites should be spread apart in the sky. The best condition is one satellite above the receiver and others evenly distributed in the sky with good visibility by the receiver. In best scenarios, if all the satellites have angle of 60 degrees to one another, that geometry of satellites can provide more accurate results for positioning. Angles of less than 30 degrees result in satellites which are either close to one another or aligned on the same line that connects them to the receiver. Very wide angles such as 150 degrees also provide satellites which are very far from one another and hence they can only be visible from the horizon with respect to a GPS receiver. Such cases provide bad geometry for satellite positioning. Satellites in the proximity of other satellites and/or satellites aligned on the same plane (i.e. forming a coplanar problem) are normally not useful in location determination as they provide redundant information about receiver. For example, two satellites which are close to one another provide the same range estimation to the receiver and hence one of range estimations can be ignored. Similarly, when satellites are aligned in such a way that the plane which passes through them also passes through the receiver location (or close by locations) the range estimation from the satellites to the receiver are not independent and become redundant. In both cases, the algorithm which solves the range estimation equations to find the receiver location will fail (or converge very slowly) as its input includes redundant data.

The term DOP₀ only applies to the cases where the receiver can see four or more satellites as described below. With fewer satellites, it is mathematically impossible to obtain a DOP₀ value when traditional methods are used.

The traditional method of obtaining all DOP₀ metrics is to use the estimated location of receiver, (xᵣ,yᵣ,zᵣ), and each of the visible satellites (four or more), (xₛ_{ᵢ},yₛ_{ᵢ},zₛ_{ᵢ}), where i indicates the index of the visible satellite. The SPS system forms a geometry matrix

$$G = [ \begin{matrix}Δ {x}_{1} & Δ {y}_{1} & Δ {z}_{1} & - 1 \\ ⋮ & ⋮ & ⋮ & ⋮ \\ Δ {x}_{n} & Δ {y}_{n} & Δ {z}_{n} & - 1\end{matrix} ]$$

where each Δ component can be determined as follows,

$$Δ {x}_{i} = \frac{{x}_{r} - {x}_{{s}_{i}}}{{R}_{i}}$$

$$Δ {y}_{i} = \frac{{y}_{r} - {y}_{{s}_{i}}}{{R}_{i}}$$

$$Δ {z}_{i} = \frac{{z}_{r} - {z}_{{s}_{i}}}{{R}_{i}}$$

where Rᵢ is the estimated range between the estimated receiver location and i the satellite.

It should be noted that matrix G has dimension n×4, where n represents the number of visible satellites. The next step to determine the DOP₀ values is to form another matrix H=G^{T}×G with dimensionality of 4×4 (^{T} represents transpose of a matrix). The inverse of matrix H, denoted by H⁻¹, is used to determine the DOP values. The diagonal elements of H⁻¹ are used to form Position Dilution of Precision (PDOP) and Time Dilution of Precision (TDOP). Other DOP₀ values, such as HDOP or Vertical Dilution of Precision (VDOP), are computed similarly.

The mathematical representation of DOP₀ values can be related to the geometry of the set of satellites. In principle, a good set of satellites for SPS is a set of satellites that are well-spread in the sky. Very close satellites or coplanar satellites provide very little information about the receiver's position. FIG. 1 illustrates a good set of satellites versus a bad set of satellites. Relating the geometry of satellites to DOP₀ values, we can conclude that a good set of satellites results in smaller DOP₀ values and a bad set of satellites results in large DOP₀ values. Therefore, it is very instructive and significant to obtain DOP₀ values for a specific set of satellites relative to an estimated receiver location. The positioning system, in our case an integrated WLAN-PS and SPS environment, can effectively decide if a set of satellites is usable for positioning or if it has a bad geometry and will produce large location error. The DOP₀ value is directly related to the volume of the tetrahedron formed using each satellite as an end point of the tetrahedron (in case of four satellites) or similar shapes (in case of more than four satellites) formed by the satellites.

As can be seen from the equations, the smallest number of satellites to form an invertible H matrix is four. In SPS, fewer than four satellites results in H_{4×4} with dependent rows and consequently H⁻¹ does not exist. This fact poses a problem for hybrid positioning schemes with fewer than four visible satellites. The goal is for a positioning scheme to assess the quality of a set of visible satellites. What is needed is a metric to relate the geometry of the visible satellites to quality of the set of visible satellites and to improve the quality of the estimate of the receiver's location when fewer than four satellites are present.

### SUMMARY

The disclosed subject matter relates to a method for determining a Dilution of Precision Metric (DOP) with less than four satellites in a hybrid positioning system. In some embodiments, the method includes determining an initial position estimate of a device using a non-satellite positioning system, obtaining satellite measurements from less than four satellites, wherein the measurements include each satellite's position with respect to the initial position estimate, constructing a geometry matrix corresponding to the measurements from the less than four satellites using each satellite's position and the initial position estimate, multiplying the geometry matrix by its transpose to construct an H matrix, determining an inverse of the H matrix, and determining the DOP based on a sum of the diagonal elements of the inverse H matrix. In some embodiments, the non-satellite positioning system is a WLAN positioning system. In some embodiments, the method includes obtaining satellite measurements from three satellites.

In some embodiments, the method includes selecting a set of satellites based on the value of the DOP. In some embodiments, the method includes selecting a set of satellites to integrate in hybrid positioning system with the non-satellite positioning system if the DOP is small. In some embodiments, a small DOP corresponds to set of satellites which display good geometry in reference to the location of the mobile device. In some embodiments, a small value of DOP comprises a value between about 1.4 to about 2.5. In some embodiments, the method includes not selecting the set of satellites to determine the position the mobile device and reporting the initial position estimate if DOP is large. In some embodiments, a large DOP corresponds to satellites that are display poor geometry in reference to the position of the mobile device. In some embodiments, a large value of DOP comprises 3.0.

One aspect of the present disclosure relates to a method including determining an initial position estimate of a device using a non-satellite positioning system, obtaining satellite measurements from a set of three satellites, wherein the measurements include each satellite's position with respect to the initial position estimate, rotating the set of satellites to form a rotated set of satellites having standard coordinates, determining a rotated geometry matrix using angles between the rotated set of satellites and the set of rotated axes, multiplying the geometry matrix by a transpose of the rotated geometry matrix to create an H matrix, and determining a DOP based on the diagonal elements of the inverse of the H matrix. In some embodiments, the non-satellite positioning system is a WLAN positioning system. In some embodiments, the method includes selecting a set of satellites based on the value of DOP. In some embodiments, the method includes selecting a set of satellites to integrate in the hybrid positioning in order to improve the position estimate if the DOP is small. In some embodiments, a small DOP corresponds to set of satellites which display good geometry in reference to the location of the mobile device. In some embodiments, the method includes refining the initial position estimate if the DOP is small. In some embodiments, a small value of DOP comprises a value between about 1.4 to about 2.5. In some embodiments, the method includes reporting the initial position estimate if the DOP is large. In some embodiments, a large DOP corresponds to satellites that display poor geometry in reference to the position of the mobile device. In some embodiments, a large value of DOP comprises 3.0.

In one aspect, the disclosed subject matter relates to a method for determining a Dilution of Precision Metric (DOP) with less than four satellites in a hybrid positioning system, the method including determining an initial position estimate of a device using a non-satellite positioning system, obtaining satellite measurements from less than four satellites, wherein the measurements include each satellite's position with respect to the initial position estimate, and determining a DOP based on the initial position estimate and the satellite measurements from less than four satellites. In some embodiments, the non-satellite positioning system is a WLAN positioning system. In some embodiments, the method includes obtaining satellite measurements from two satellites. In some embodiments, the DOP is related to the angle between the two satellites with respect to the initial position estimate. In some embodiments, the method includes obtaining satellite measurements from three satellites. In some embodiments, the method includes selecting a set of satellites based on the value of DOP. In some embodiments, the method includes selecting a set of satellites to integrate in the hybrid positioning in order to improve the position estimate if the DOP is small. In some embodiments, a small DOP corresponds to set of satellites which display good geometry in reference to the location of the mobile device. In some embodiments, the method includes refining the initial position estimate if the DOP is small. In some embodiments, a small value of DOP comprises a value between about 1.4 to about 2.5. In some embodiments, the method includes reporting the initial position estimate if the DOP is large. In some embodiments, a large DOP corresponds to satellites that display poor geometry in reference to the position of the mobile device. In some embodiments, a large value of DOP comprises 3.0.

### BRIEF DESCRIPTION OF THE DRAWINGS

For a more complete understanding of various embodiments of the present invention, reference is now made to the following descriptions taken in connection with the accompanying drawings in which:

FIG. 1A illustrates a configuration of satellites that provides an accurate position determination, according to an embodiment of the present disclosure;

FIG. 1B illustrates a configuration of satellites that provides an inaccurate position determination, according to an embodiment of the present disclosure;

FIG. 2 illustrates the spread of two satellites with respect to a receiver's location in a plane defined by the two satellites and the receiver's location, according to an embodiment of the present disclosure;

FIG. 3 illustrates the example of FIG. 2 in a two dimensional plane and the respective angles, according to an embodiment of the present disclosure;

FIG. 4 illustrates poor satellite geometry with two satellites and shows a large region in which receiver could be located, according to an embodiment of the present disclosure;

FIG. 5 illustrates a three satellite embodiment and the respective DOP₂ values, according to an embodiment of the present disclosure;

FIG. 6 illustrates three satellites in 3D space, including their angles with respect to each axis, according to an embodiment of the present disclosure; and

FIG. 7 illustrates the configuration of FIG. 6 in 3D space where the first satellite is on the x-axis and the second satellite in on x-y plane, according to an embodiment of the present disclosure.

### DETAILED DESCRIPTION

The present disclosure describes a new technique for a positioning system, which uses an initial estimated location (IEL) from a WLAN positioning system and SPS satellite information to assess the quality of set of SPS measurements or individual satellites to be used in a position determination. The present disclosure also relates to evaluating the quality of set of satellite positioning system (SPS) measurements and to improving the quality of SPS location estimation by accepting/rejecting satellite information. This system can be used when the receiver sees less than four satellites, for example, two or three satellites. Specifically, the disclosure describes a new method used to evaluate the dilution of precision (DOP) metric, when less than four satellites are visible.

The embodiments also utilize the geometry of visible satellites to decide if the current set of visible satellites (either two or three satellites) are appropriate to be used for positioning and consequently to improve the overall quality of estimate of the predicted location reported by positioning system.

In order to do so, the method relates the geometry of the visible satellites to the predicted location of the receiver when only two or three satellites are visible. Note that the phrase “geometry of satellites” is used to describe the geometry of visible satellite with respect to the estimated receiver location throughout this disclosure. As discussed above, the DOP metric is a well-known metric in satellite positioning and is used to assess the quality of set of satellites that are used for location determination. In this disclosure, a method is described to assess the quality of set of satellites when the set has only two or three satellites and an initial position of the device.

The provided technique in the embodiments can improve the quality of the estimated location in an integrated WLAN-PS and SPS environment. In such hybrid positioning systems, the final reported location can be one of the following;
1) WLAN-PS reported location along with its quality of estimate
2) SPS reported location in scenarios with four or more visible satellites along with its quality of estimate or
3) A combination of WLAN-PS and SPS reported locations.

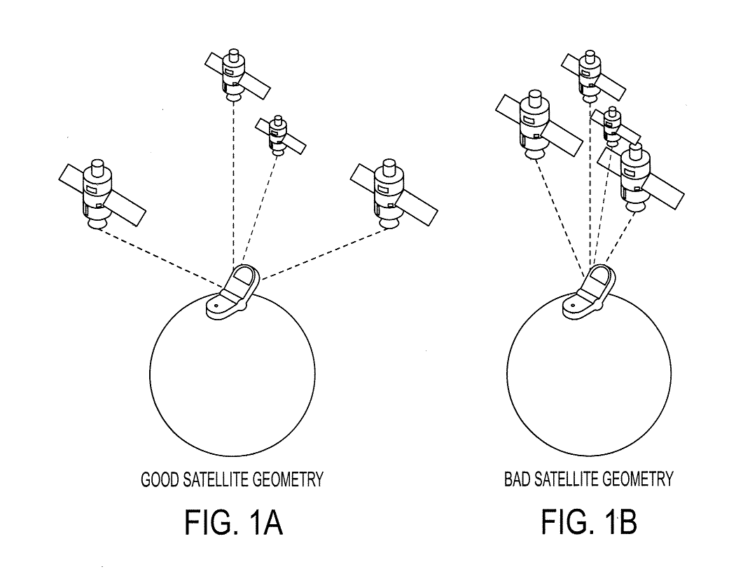

The quality of estimate metric in the latter case should consider the aggregate measurements from both WiFi access points and satellites' range information and range position information. Generally, the quality of estimate in an integrated WLAN-PS and SPS environments can include a combination of the quality of the WLAN-PS reported location and the dilution of precision (DOP₀) of SPS when satellites are in range and their position information is available. Referring to FIG. 1, one can observe good satellite geometry for SPS where satellites are spread in sky (shown in FIG. 1A) versus bad satellite geometry (shown in FIG. 1B) where satellites are in close proximity of each other.

Traditional DOP₀ metrics are obtained from the locations of four or more visible satellites at any specific time and location. According to the location of the visible set of satellites and predicted location of the receiver, we form a geometry matrix, denoted by G, including the unit vectors connecting the receiver location to position of each satellite. The clock bias is included by appending −1 at the end of each vector. Each row in the geometry matrix then includes of four elements.

$$G = [ \begin{matrix}Δ {x}_{1} & Δ {y}_{1} & Δ {z}_{1} & - 1 \\ ⋮ & ⋮ & ⋮ & ⋮ \\ Δ {x}_{n} & Δ {y}_{n} & Δ {z}_{n} & - 1\end{matrix} ]$$

Traditional DOP metrics are obtained by inversion of the H=G^{T}×G where ^{T} represents transpose function. With n visible satellites, the dimension of H is 4×4 with rank n=4. The inversion of this matrix results in another 4×4 matrix whose diagonal elements can be used to determine different DOP₀ metrics. However, when fewer than four satellites are visible, the dimension of matrix H is 4×4 with rank n<4, i.e. H is rank-deficient. This results in a non-invertible H matrix and hence the DOP₀ values cannot be obtained because there are not enough measurements to create the appropriate matrix.

SPS uses at least four satellites to estimate the inaccuracies of estimated receiver location. These inaccuracies include x,y,z coordinate inaccuracies as well as receiver clock time inaccuracies. If one of the parameters is estimated perfectly and does not have any inaccuracy it can be effectively excluded from the DOP estimation and a fewer number of satellites would be required to solve for receiver location and DOP calculation. In the case of hybrid positioning systems, prior knowledge of the receiver location can indicate if the system was able to estimate the clock bias correctly and hence clock bias inaccuracies do not exist. This leads us to disregard the time variations in G and disregard the last column consisting of −1.

This disclosure describes a method to provide a DOP metric, referred to as DOP₂, for the cases where only two satellites are visible to the receiver. In such cases, it also provides a means for accepting or rejecting a set of satellites to be used in a positioning system. Note that DOP₂ has different scale compared to traditional DOP₀ metric but it behaves similarly. Smaller values of DOP₂ indicate good satellite geometry and larger values of DOP₂ indicate bad satellite geometry.

The disclosure then describes three different approaches to determine another DOP metric, referred to as DOP₃, for cases where only three satellites are visible to the receiver. For such cases, the invention describes a satellite selection method. This method also can be used to accept/reject the entire set of satellites to be used in a positioning system. Similar to the DOP₂ metric, the DOP₃ metric provides a means to indicate if geometry of satellite is usable for a positioning system.

### Case I: Two Satellites

First, the embodiment using two satellites will be described. In this embodiment, it is assumed (1) the hybrid positioning system, for example as WLAN Positioning System (WLAN-PS), has an estimate of the receiver location which is referred to as initial estimated location (IEL), (2) there exist two visible satellites in the range of receiver's location device and (3) SPS is able to obtain range estimates and satellite information from these two satellites. The following method is used to determine whether or not the hybrid positioning system will use the satellite measurements for the final location determination. If, through the following method, it is determined that the satellites will provide accurate position measurements, then the satellites can be used in conjunction with the WLAN positioning system to determine the position of a device. However, if it is determined that the detected satellites are in such a configuration that they would provide inaccurate measurements, i.e., the satellites have a poor geometry with respect to each other, the satellite data can be ignored and the position determination can be made solely using the WLAN positioning system information.

In this embodiment, the geometry of only two satellites is related to the quality of the set of satellites. The defined metric, describing the quality of set of satellites, can be used to improve the estimated location using an aggregate of WiFi access points and satellites measurements. This provides a means to obtain a DOP-like metric, referred to herein as DOP₂, for the cases where only two satellites are visible to the receiver. If the DOP-like metric indicates a favorable satellite geometry, the range measurements from satellites can be used to both provide a better location estimation and to improve the overall quality of estimate of the receiver location reported by the positioning system (i.e. positioning system can be a hybrid positioning system which can refine the IEL by employing the range measurements from visible satellites). However, if the DOP-like metric indicates unfavorable satellite geometry, the satellite measurements can be discarded.

The position information of the satellites can be related to the quality of that set of satellites to be used in positioning system when only two satellites are visible by the receiver. In such cases, the system then has to decide if satellites are close to one another with respect to IEL. In the case of only two visible satellites, a good metric to measure the quality of the set of the satellites is the angle of the two satellites with respect to IEL. The DOP₂ metric, in case of two satellites, can be related to the angle between the satellites with respect to the initial estimated location.

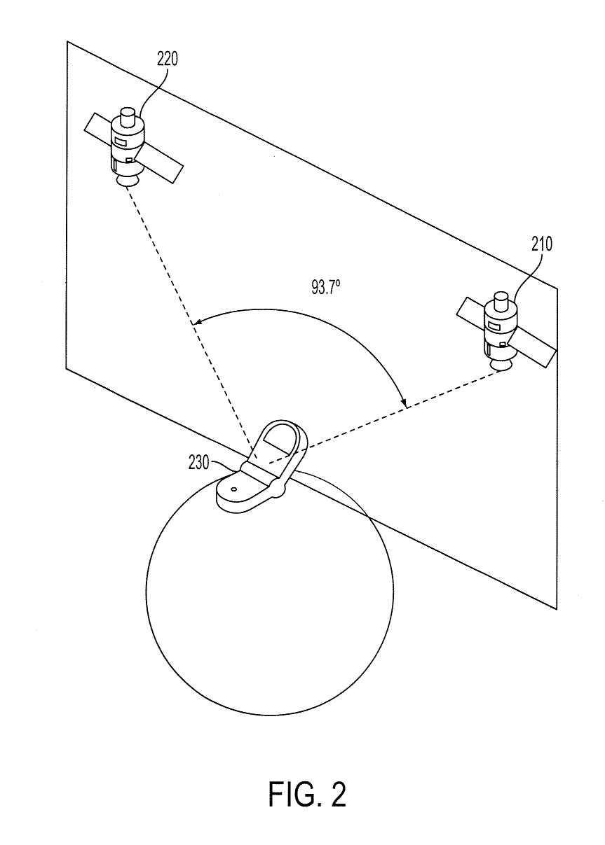

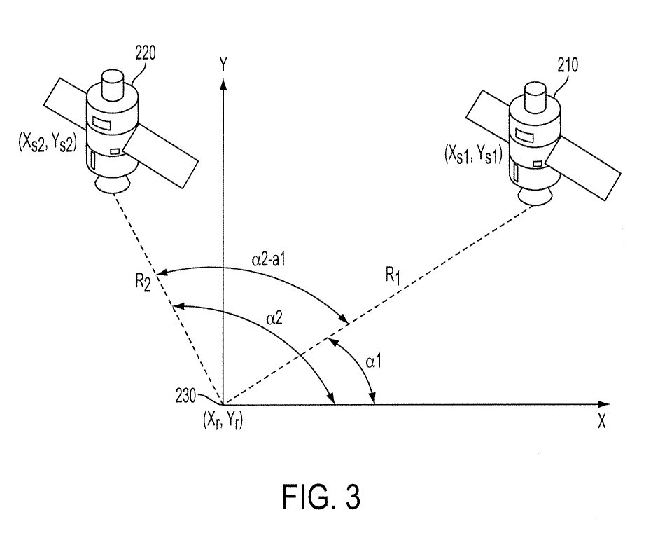

As can be seen from FIG. 2, a first satellite 210, a second satellite 220 and the IEL of receiver 230 (total of three points in 3D space) define one plane 240. Thus, it is possible to obtain the angle 250 between the satellites 210, 220 in normal XYZ coordinates. However, it is not essential and the angle between the satellites with respect to IEL can easily be obtained following the described procedure. Rotating the plane containing the two satellites and the IEL as illustrated in FIG. 2 will result in what is shown in FIG. 3 and we will continue with notation of FIG. 3. The rotation of the plane reduces a 3-D problem to a 2-D problem and hence reduces variables and numbers used for the calculation.

The disclosed method uses the unit vectors connecting the IEL to each satellite and measures the angle between the satellites. Note that the phrase “angle between two satellites” refers to the measure of an angle between the satellites with respect to the IEL. The hybrid positioning system had previously determined the IEL using a WLAN positioning system. The hybrid positioning system then utilizes the satellite information from each of the two visible satellites. The satellite information contains the XYZ position of each satellite and hence the positioning system can find the distance between the IEL and each satellite and then form the unit vector connecting the IEL to satellite position.

If we assume that we have two satellites 210, 220 in a 2D plane, we can use a similar DOP₂ metric and find if the satellites are well distributed.

In 2D case, referring to FIG. 3, we have

$$Δ {x}_{1} = \frac{{x}_{r} - {x}_{{s}_{1}}}{{R}_{1}} = cos ( {α}_{1} ) Δ {x}_{2} = \frac{{x}_{r} - {x}_{{s}_{2}}}{{R}_{2}} = cos ( {α}_{2} )$$

$$and$$

$$Δ {y}_{1} = \frac{{y}_{r} - {y}_{{s}_{1}}}{{R}_{1}} = sin ( {α}_{1} ) Δ {y}_{2} = \frac{{y}_{r} - {y}_{{s}_{2}}}{{R}_{2}} = sin ( {α}_{2} )$$

where (xᵣ,yᵣ) represent the receiver location in 2D plane, (xₛ_{ᵢ},yₛ_{ᵢ}) represent the ith satellite position in the 2D plane, xᵢ represents the angle between the x-axis and the first satellite 210, and x₂ represents the angle between the x-axis and the second satellite 220.

Forming the G matrix, also referred to as the geometry matrix, and disregarding the time variations, we have

$$G = [ \begin{matrix}Δ {x}_{1} & Δ {y}_{1} \\ Δ {x}_{2} & Δ {y}_{2}\end{matrix} ] = [ \begin{matrix}cos ( {α}_{1} ) & sin ( {α}_{1} ) \\ cos ( {α}_{2} ) & sin ( {α}_{2} )\end{matrix} ]$$

Forming the H matrix from the G matrix, we have

$$H = {G}^{T} \times G = [ \begin{matrix}cos ( {α}_{1} ) & cos ( {α}_{2} ) \\ sin ( {α}_{1} ) & sin ( {α}_{2} )\end{matrix} ] \times [ \begin{matrix}cos ( {α}_{1} ) & sin ( {α}_{1} ) \\ cos ( {α}_{2} ) & sin ( {α}_{2} )\end{matrix} ]$$

In order to find the inverse of H matrix, we can start with finding the determinant of H, i.e. |H|=sin²(α₁−α₂).

Therefore, H⁻¹ is computed as

$${H}^{- 1} = \frac{1}{\vert H \vert} [ \begin{matrix}{sin}^{2} ( {α}_{1} ) + {sin}^{2} ( {α}_{2} ) & \begin{matrix}- cos ( {α}_{1} ) sin ( {α}_{1} ) + \\ cos ( {α}_{2} ) sin ( {α}_{2} )\end{matrix} \\ \begin{matrix}- cos ( {α}_{1} ) sin ( {α}_{1} ) + \\ cos ( {α}_{2} ) sin ( {α}_{2} )\end{matrix} & {cos}^{2} ( {α}_{1} ) + {cos}^{2} ( {α}_{2} )\end{matrix} ]$$

By definition, the DOP₂ value can be extracted as DOP₂=\sqrt{H₁₁⁻¹+H₂₂⁻¹} which is

$$\begin{matrix}{DOP}_{2} = \sqrt{\frac{1}{\vert H \vert} ( {cos}^{2} ( {α}_{1} ) + {cos}^{2} ( {α}_{2} ) + {sin}^{2} ( {α}_{1} ) + {sin}^{2} ( {α}_{2} ) )} \\ = \sqrt{\frac{2}{{sin}^{2} ( {α}_{1} - {α}_{2} )}} \\ = \frac{\sqrt{2}}{\vert sin ( {α}_{1} - {α}_{2} ) \vert}\end{matrix}$$

If the angle between the satellites, θ=α₁−α₂, is small, |sin(θ)| is small and DOP₂ is large. Large values of DOP₂ demonstrate poor satellite geometry (i.e. satellites are close to one another or are collinear) and small values of DOP₂ indicate good satellite geometry.

From the 2D case, it can be observed that the best case for two satellites to provide position information is for them to have angle of

$${α}_{1} - {α}_{2} = \frac{π}{2} = {90}^{°} .$$

This results in DOP₂=\sqrt{2}, which is the minimum for DOP₂. Values of DOP₂ in the range of 1.4 to about 2.5, preferably about 1.65, indicate good satellite geometry and therefore indicate a reliable set of satellites for positioning purposes. DOP₂ values that are above 3.0 indicate are too high and indicate a set of satellites with poor geometry. Therefore, a set of satellites with a DOP₂ greater than 3.0 are unreliable for positioning purposes.

By choosing a threshold angle, γ°, we can conclude that if angle between satellites, θ, fulfills the following conditions, then the set of satellites can effectively be used for positioning.

θ>γ°

θ<π−γ°

Alternatively, we can summarize the above equations as γ°<θ<π−γ°. We can instead define the range of possible angles as Θ=[γ°,π−γ°] and if θ∉Θ we can use the set of satellites for positioning. For example, if the angle between the satellites is less than 30 degrees, those satellites will not result in a reliable position determination. However, if the angle between the satellites is greater than 30 degrees, those satellites can result in a reliable position determination and should be used. The angles between two satellites which are in the range of 30 degrees and 150 degrees are preferred for hybrid positioning while the angles outside of this range usually provide bad geometry for satellites in order to be used for hybrid positioning.

If the angle between the two satellites satisfies the above threshold, the set of satellites can be used to obtain a better location and to improve the quality of estimate of the reported location. Otherwise, the satellites are too close to one another and their distance measurements are not completely uncorrelated and hence can not be used for positioning receiver's location. Mathematically,

ANGLE(S₁,S₂)=cos⁻¹(v₁·v₂)

where v₁=(Δx₁,Δy₁,Δz₁) and v₂=(Δx₂,Δy₂,Δz₂) are unit vectors from predicted location of the receiver to satellites S₁ and S₂ and (•) represents the dot product. If vectors v₁ and v₂ are not normalized, the angle can be represented as

$$ANGLE ( {S}_{1} , {S}_{2} ) = {cos}^{- 1} ( \frac{{v}_{1} \cdot {v}_{2}}{‖ {v}_{1} ‖ ‖ {v}_{2} ‖} )$$

More formally, if

$$Δ {x}_{i} = \frac{{x}_{r} - {x}_{{s}_{i}}}{{R}_{i}}$$

$$Δ {y}_{i} = \frac{{y}_{r} - {y}_{{s}_{i}}}{{R}_{i}}$$

$$Δ {z}_{i} = \frac{{z}_{r} - {z}_{{s}_{i}}}{{R}_{i}}$$

$${R}_{i} = \sqrt{{( {x}_{r} - {x}_{{s}_{i}} )}^{2} + {( {y}_{r} - {y}_{{s}_{i}} )}^{2} + {( {z}_{r} - {z}_{{s}_{i}} )}^{2}}$$

$${v}_{1} = ( Δ {x}_{1} , Δ {y}_{1} , Δ {z}_{1} )$$

$${v}_{2} = ( Δ {x}_{2} , Δ {y}_{2} , Δ {z}_{2} )$$

$${v}_{1} \cdot {v}_{2} = Δ {x}_{1} Δ {x}_{2} + Δ {y}_{1} Δ {y}_{2} + Δ {z}_{1} Δ {z}_{2}$$

As we defined in the 2D case,

$$\begin{matrix}{DOP}_{2} = \frac{\sqrt{2}}{sin ( • ( {S}_{1} , {S}_{2} ) )} \\ = \frac{\sqrt{2}}{sin ( {cos}^{- 1} ( {v}_{1} \cdot {v}_{2} ) )} \\ = \frac{\sqrt{2}}{\sqrt{1 - {( {v}_{1} \cdot {v}_{2} )}^{2}}} \\ = \sqrt{\frac{2}{1 - {( {v}_{1} \cdot {v}_{2} )}^{2}}}\end{matrix}$$

We compare DOP₂ to a fixed threshold to declare if the set of satellites are usable for positioning.

For the example of integrated WLAN-PS and SPS environment, it can be decided that two very close satellites (as measured by the angle-between-satellites sense) are not likely to provide sufficient information for hybrid positioning system. One example for angle threshold, γ₁°, can be considered to be around 30°. Mathematically, the process can be represented as following:

The DOP₂ threshold can be determined by

$${ϕ}_{1} = \frac{\sqrt{2}}{sin ( {γ}_{1}^{∘} )} .$$

|DOP₂|>φ₁ [symbol] ANGLE(S₁,S₂)∉Θ then set of satellites can not be used for positioning. On the other hand, |DOP₂|≦φ₁ [symbol] ANGLE(S₁,S₂)∉Θ and set of satellites can be used for positioning.

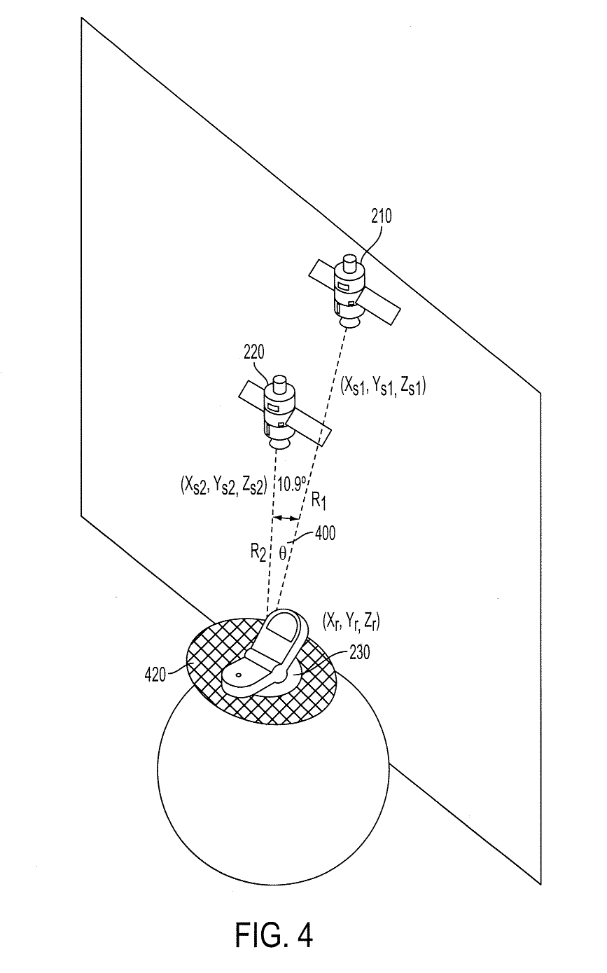

This method also provides a means for satellite selection in a hybrid positioning system. It allows the hybrid positioning system to either reject the current set of visible satellites, i.e. only uses WLAN-PS reported location, or accept the satellite information and range measurements to be used for hybrid positioning. If two satellites are relatively close to one another, their angle is not in Θ, their range measurements will most likely provide a very large region in which the receiver could be located. Consequently, the location accuracy decreases, as receiver could be anywhere in the region. The concept is depicted in FIG. 4. FIG. 4 depicts two satellites 210, 220 with a small angle 400 between them, and a large location region 420. In such cases, hybrid positioning system would choose not to use the satellite information and would rely solely on the WLAN positioning information.

### Possible Modifications and Variations

For practical implementations, it may be best to compare the results of vector manipulation to a fixed threshold to determine on the DOP₂ value. Note that DOP₂ is only function of the angle between the satellites and hence it is only necessary to obtain some information about that angle. It is computationally more efficient to use only the relative positions of the satellites (with respect to initial location) and calculate the DOP₂ metric (as opposed to calculating the angle between the satellites from the same vectors and then calculating the DOP₂ metric based on that angle). For example, the dot product between two normalized vectors represents the cosine value of the angle of those two vectors. Here we propose to compute the dot product of the normalized vectors instead of finding the dot product and then finding the angle from the result of the dot product. This will result in computationally more efficient algorithm to find information regarding the angle between the satellites.

We can define the following as an alternate DOP₂ value:

DÔP₂=v₁.v₂ for the case when vectors v₁ and v₂ are normalized or

$$D \hat{O} {P}_{2} = \frac{{v}_{1} \cdot {v}_{2}}{‖ {v}_{1} ‖ ‖ {v}_{2} ‖} = ANGLE ( {S}_{1} , {S}_{2} )$$

when they are not normalized.

We can compare it directly to another threshold to decide if the set of satellites is usable for positioning.

For example, if we decide to use the 30° degree value and reject satellites whose angles with respect to each other is less than 30°, we can find

$${ϕ}_{2} = cos ( \frac{30 \times π}{180} ) = 0.866 ,$$

where φ₂ is the new threshold. We applied φ₁ when we used equation in [0049] to determine if two satellites are close. We apply φ₂ when we use equation in [0054] to determine if satellites are close. In other words, instead of performing an additional step (calculating the angle between the satellites) and comparing the results to φ₁, we compare the product of the vectors to another threshold, φ₂. We then compare DÔP₂ to φ₂. The process can be summarized as following: Similar to the procedure described above the new DOP₂, DÔP₂, can be compared to its threshold, φ₂, to determine if the current set of two satellites can be used for positioning. |DÔP₂|>φ₂ [symbol] ANGLE(S₁,S₂)∉Θ and set of satellites can not be used for positioning. On the other hand |DÔP₂|≦φ₂ [symbol] ANGLE(S₁,S₂)∉Θ and set of satellites can be used for positioning. The equations signify that if the calculated DÔP₂ is greater that its threshold, φ₂, the angle between two satellites is smaller than angle threshold, γ₁°, and consequently the set of two satellites cannot be used for positioning. On the other hand, if the calculated value of DÔP₂ is smaller than φ₂, then angle between two satellites is larger than its threshold and the set can be used for positioning.

Note that value of φ₁ is different from φ₂, but they are related to one another by

$$\frac{2}{{ϕ}_{1}^{2}} + {ϕ}_{2}^{2} = 1.$$

Calculating DÔP₂ and comparing it with φ₂ is more computationally efficient and less time consuming for selecting the best satellites and/or determine if a set of two satellites can be used for positioning.

### Case II: Three Satellites

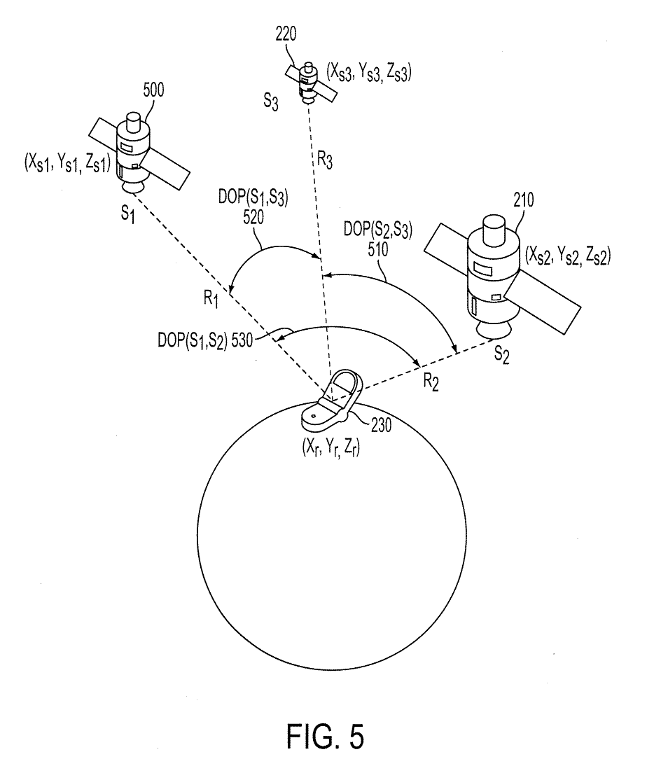

Another aspect of the present disclosure relates to evaluating the quality of satellite geometry where three satellites are in view. The case with three satellites is very similar to the two satellites embodiment. It is assumed that a positioning system has an IEL and is able to acquire signal from three satellites including pseudorange estimates and satellite information from these three satellites. To illustrate the concept of the present embodiment, FIG. 5 depicts a three satellite constellation; including a first satellite 210, a second satellite 220, and a third satellite 500 all located above the receiver location 230. DOP(S1,S2) 530 refers to the angle between first satellite and second satellite, DOP(S1,S3) 520 is the angle between the first satellite and third satellite, and DOP(S2,S3) 510 is the angle between the second satellite and third satellite.

The three satellite embodiment proposes three different approaches to obtain the relationship geometry between the satellites and the IEL. The first approach is similar to the case with two satellites: the positioning system obtains the angles between each pair of satellites, and based on the obtained angles it evaluates the quality of the satellite measurements. The first approach yields a value DOP₃ₐ.

The second approach is to use the position information of the satellites and form a DOP₃ matrix (similar to traditional DOP matrix in SPS systems). The difference between the proposed matrix and traditional DOP matrix is the exclusion of the time inaccuracies from the DOP matrix (i.e. exclusion of the last column in the matrix, containing −1 for all satellites). The approach then continues similar to the traditional DOP method. The second approach yields a value DOP_{3b}.

The third approach is to translate the problem into a trigonometric problem by transforming the individual elements of the DOP₃ matrix defined in the second approach to their equivalent trigonometric functions and simplifying the matrix. The positioning system then relates the geometry of the visible satellites to the quality of set of satellites to be used in positioning system. The third approach yields a value DOP_{3c}.

If the metrics corresponding to the geometry fulfill the preferred guidelines, the positioning system can employ the measurements from these three satellites to refine the initial location and improve the quality of estimated location. Note that although the approaches are different in scale, they behave similarly. The DOP₃ metrics obtained from these approaches indicate if the current set of three satellites is usable for positioning. All three approaches result in a DOP₃ metric (different from the DOP₃ matrix), which if sufficiently small, can indicate the geometry of satellites is good for positioning.

Below, we explain these three different approaches to find a form of DOP₃ metric for the three satellite case, where only three satellites are visible to the receiver and the receiver is able to receive information from these three satellites.

### First Approach

In the first method for the case of three satellites, similar to the method described for two satellites, we find the angles between the vectors connecting the predicted receiver location and each pair of satellites.

If the angles between each pair of satellites were in Θ, we can use all the three satellites for positioning, since they would all be well spread in the sky. If one pair had an angle not in Θ, we can reject that pair and select either of the remaining two pairs.

In this embodiment, DOP₃ₐ=(DOP₂(S₁,S₂), DOP₂(S₁,S₃), DOP₂(S₂,S₃)) where DOP₂(S₁,S₂) represents the angle between S₁ and S₂ DOP₂(S₁,S₃) represents the angle between S₁ and S₃ and DOP₂(S₂,S₃) represents the angle between S₂ and S₃. If all the DOP₂ values were more than the threshold, we could use all the three satellites for positioning, otherwise, two satellites would be close to one another and at least one of them would have to be rejected for positioning.

For example, if |DOP₂(S₁,S₂)| exceeds the threshold, we learn that S₁ and S₂ are close to one another and hence only one of them can be used for positioning.

The threshold for DOP₃ₐ and its subset DOP₂ values can be different from the case of two satellites only. In this case, we can restrict the spread of the satellites differently and increase the angle threshold. For example, we can define the angle threshold, γ₃° to be around 35°. In such case, each individual DOP₂ value is compared against a new threshold. The restriction on the angle between satellites can be less strict when we have three satellites in view. Generally, having three satellites can provide better location estimation than cases with two satellites. The range of angles between satellites which are beneficial to hybrid positioning can be defined as angles between 35 degrees and 145 degrees.

If only one set of satellites had an angle smaller than γ₃°,

i.e. ANGLE(S₂,S₃)∉Θ, we can use either (S₁,S₂) or (S₁,S₃). The selection of satellites can be determined using another SPS metric, such as signal-to-noise ratio.

If two sets had angles smaller than γ₃°, i.e. only ANGLE(S₁,S₂)∉Θ, we have to use the remaining set, (S₁,S₂), as the final satellite selection. Finally, if all three sets had angles smaller than γ₃°, we can conclude that all satellites are located in the same region of the sky and the set cannot be used for accurate positioning. The best scenario consists of three satellites with pair-wise angles in Θ which means the geometry of current set of satellites is good for positioning and the positioning system (such as integrated WLAN-PS and SPS environments) can use all three satellites to both obtain a better location and to improve the quality of estimate of the reported location.

It is also possible to compare the results of vector manipulation to another threshold to calculate the DÔP₃ₐ value.

We can define the following as an alternate DOP₃ value

DÔP₃ₐ=(v₁.v₂,v₁.v₃,v₂.v₃) when the vectors are normalized or

$$D \hat{O} {P}_{3 a} = ( \frac{{v}_{1} \cdot {v}_{2}}{‖ {v}_{1} ‖ ‖ {v}_{2} ‖} , \frac{{v}_{1} \cdot {v}_{3}}{‖ {v}_{1} ‖ ‖ {v}_{3} ‖} , \frac{{v}_{2} \cdot {v}_{3}}{‖ {v}_{2} ‖ ‖ {v}_{3} ‖} )$$

when they are not normalized and we compare it to another threshold to decide if the set of satellite is usable for positioning.

For example, if we decide to use the 35° degree threshold and reject satellites separated by an angle less than 35°, we can find

$${ϕ}_{3} = cos ( \frac{35 \times π}{180} ) = 0.8192 ,$$

where φ₃ is the threshold. We then compare all components of DÔP₃, to φ₃. The process can be summarized as follows.

If ANGLE(S₂,S₃)∉Θ, while ANGLE(S₁,S₂)∉Θ and ANGLE(S₁,S₃)∉Θ, then we have to choose between either (S₁,S₂) and (S₁,S₃). The selection can be performed using other SPS metrics such as signal-to-noise ratio. If only ANGLE(S₁,S₂)∉Θ while ANGLE(S₂,S₃)∉Θ and ANGLE(S₁,S₃)∉Θ, we must use the (S₁,S₂).

If ANGLE(S₁,S₂)∉Θ, ANGLE(S₂,S₃)∉Θ, and ANGLE(S₁,S₃)∉Θ, then we conclude than this set of satellites is not well spread in sky and are located in the same region. Therefore, they cannot be used for positioning. Finally, if the entire set had good geometry characteristics, i.e. ANGLE(S₁,S₂)∉Θ, ANGLE(S₂,S₃)∉Θ, and ANGLE(S₁,S₃)∉Θ, we can use all three satellites for positioning.

In another embodiment of this invention, we propose to use these three metrics to weigh the estimated position and provide a better final position. In order to do so, we can find the estimated location based on initial location and set of (S₁, S₂). We also find the estimated location based on initial location and set of (S₁, S₃) and initial location and set of (S₂, S₃). Then we weight these three estimated locations based on individual DOP metrics of each set.

The assigned weights in the above method can be related to DOP values of each pair of the three satellites. For example, if one of the methods described earlier to obtain the DOP values, we know that the 1.4 is the best DOP value that system can obtain and 5 is much worse value for DOP. Now, if with three satellite, we obtain three angles of ANGLE(S₁,S₂) with DOP of 1.4, ANGLE(S₁,S₃) with DOP of 5, and ANGLE(S₂,S₃) with DOP of 10. We find the three refined location estimates using IEL and (S₁,S₂) as (X₁,Y₁,Z₁), IEL and (S₁,S₃) as (X₂,Y₂,Z₂), and IEL and (S₂,S₃) as (X₃,Y₃,Z₃). Then, our final location estimate comes from a combination of these refined locations with weights related to DOPs. We can use

$$\frac{1}{DOP}$$

as the weights for each refined location and define the final location as

$${X}_{F} = \frac{\frac{1}{{DOP}_{1}} {X}_{1} + \frac{1}{{DOP}_{2}} {X}_{2} + \frac{1}{{DOP}_{3}} {X}_{3}}{\frac{1}{{DOP}_{1}} + \frac{1}{{DOP}_{2}} + \frac{1}{{DOP}_{3}}}$$

$${Y}_{F} = \frac{\frac{1}{{DOP}_{1}} {Y}_{1} + \frac{1}{{DOP}_{2}} {Y}_{2} + \frac{1}{{DOP}_{3}} {Y}_{3}}{\frac{1}{{DOP}_{1}} + \frac{1}{{DOP}_{2}} + \frac{1}{{DOP}_{3}}}$$

$${Z}_{F} = \frac{\frac{1}{{DOP}_{1}} {Z}_{1} + \frac{1}{{DOP}_{2}} {Z}_{2} + \frac{1}{{DOP}_{3}} {Z}_{3}}{\frac{1}{{DOP}_{1}} + \frac{1}{{DOP}_{2}} + \frac{1}{{DOP}_{3}}}$$

Similar approaches can be used to define other weights or we can use predetermined weights for each set. It should be noted that if DOP values were obtained with another method, we can adjust the weights to take that change into consideration.

The calculation of DOP₃ₐ is computationally simple and fast as it requires simple vector manipulations and comparison. However, it performs relatively less accurate as it only compares each pair of satellites and not all three of them simultaneously.

### Second Approach

The second method of finding an alternative DOP₃ metric consists of matrix manipulations. Defining the unit vectors from IEL to each satellite, i.e.

vᵢ=(Δxᵢ,Δyᵢ,Δzᵢ), where its components are defined as

$$Δ {x}_{i} = \frac{{x}_{r} - {x}_{{s}_{i}}}{{R}_{i}}$$

$$Δ {y}_{i} = \frac{{y}_{r} - {y}_{{s}_{i}}}{{R}_{i}}$$

$$Δ {z}_{i} = \frac{{z}_{r} - {z}_{{s}_{i}}}{{R}_{i}}$$

$${R}_{i} = \sqrt{{( {x}_{r} - {x}_{{s}_{i}} )}^{2} + {( {y}_{r} - {y}_{{s}_{i}} )}^{2} + {( {z}_{r} - {z}_{{s}_{i}} )}^{2}}$$

gives us another geometry matrix or G′ matrix defined as

$${G}^{′} = [ \begin{matrix}Δ {x}_{1} & Δ {y}_{1} & Δ {z}_{1} \\ Δ {x}_{2} & Δ {y}_{2} & Δ {z}_{2} \\ Δ {x}_{3} & Δ {y}_{3} & Δ {z}_{3}\end{matrix} ]$$

Note that the above G′ matrix is very similar to the G matrix discussed above excluding the time variations. For an alternative DOP₃ metric calculation we can ignore the variations of time and its effect on the geometry of the satellites and focus on the limitations of the satellite geometry itself.

Advancing with the above procedure, similar to DOP matrix, we can form the H′=G′^{T}×G′ matrix and find its inverse, i.e. H′⁻¹. The diagonal elements of H′⁻¹ will yield the desired DOP₃ value.

DOP_{3b}=\sqrt{H′₁₁⁻¹+H′₂₂⁻¹+H′₃₃⁻¹}

It is also possible to obtain the DOP_{3b} value without actually inverting the H matrix.

### Assume

$$A = [ \begin{matrix}{a}_{11} & {a}_{12} & {a}_{13} \\ {a}_{21} & {a}_{22} & {a}_{23} \\ {a}_{31} & {a}_{32} & {a}_{33}\end{matrix} ]$$

Then we have

|A|=a₁₁(a₂₂a₃₃−a₃₂a₂₃)−a₂₁(a₁₂a₃₃−a₁₃a₃₂)+a₃₁(a₁₂a₂₃−a₁₃a₂₂)

And

A₁₁⁻¹=a₂₂a₃₃−a₂₃a₃₂

A₂₂⁻¹=a₁₁a₃₃−a₁₃a₃₁

A₃₃⁻¹=a₁₁a₂₂−a₁₂a₂₁

And finally,

$${DOP}_{3 b} = \sqrt{\frac{1}{\vert A \vert} ( {A}_{11}^{- 1} + {A}_{22}^{- 1} + {A}_{33}^{- 1} )}$$

Observe that H is a symmetric matrix and some elements are equal to one another. To more efficiently calculate DOP_{3b}, we can ignore the square root sign and compute A₁₁⁻¹, A₂₂⁻¹, and A₃₃⁻¹ and use them to find |A|. This will save computational resources.

DOP_{3b} is more accurate than DOP₃ₐ as it uses all three satellites and their respective position to find a DOP₃ metric. However, it is computationally more expensive and more time consuming than DOP₃ₐ as it requires considerably more vector manipulations. In applications where computational power is not limited and we can perform fast algebraic matrix manipulations, DOP_{3b} is preferred.

### Third Approach

The third method to find a DOP₃ value for the case of three satellites, involves transforming the G matrix into trigonometric functions and simplifying the DOP_{3c} answer.

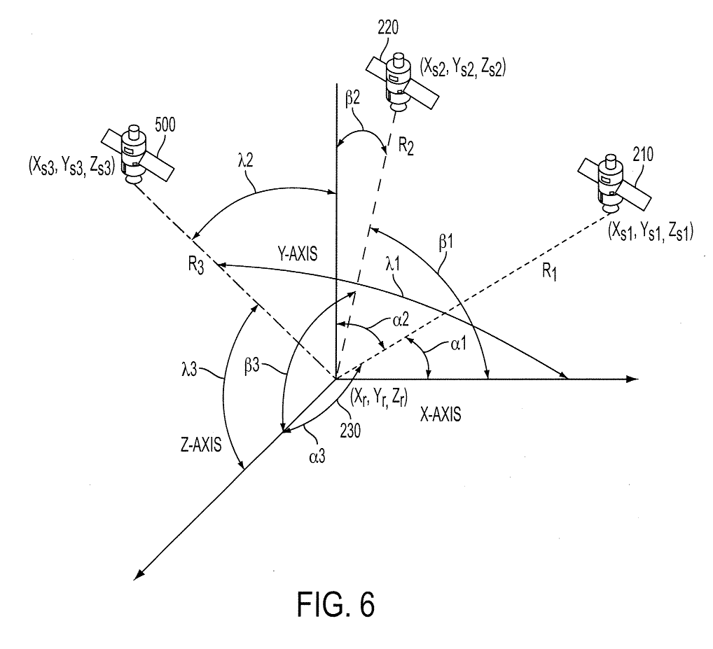

FIG. 6 illustrates the concept and different angles. FIG. 6 depicts a three satellite embodiment of the present teachings; including a first satellite 210, a second satellite 220, and a third satellite 500 all located above the receiver location 230. α₁ represents the angle between the first satellite and x-axis of the Cartesian coordinates. α₂ represents the angle between the first satellite and y-axis and α₃ represents the angle between the first satellite and z-axis. Similarly, β₁ represents the angle between the second satellite and x-axis, β₂ represents the angle between the second satellite and y-axis and β₃ represents the angle between the second satellite and z-axis. Finally, γ₁m γ₂, and γ₃ represent the angles between the third satellite and x-axis, y-axis, and z-axis, respectively.

In order to proceed, we can denote the G₁ matrix as;

$$G = [ \begin{matrix}cos ( {α}_{1} ) & cos ( {α}_{2} ) & cos ( {α}_{3} ) \\ cos ( {β}_{1} ) & cos ( {β}_{2} ) & cos ( {β}_{3} ) \\ cos ( {λ}_{1} ) & cos ( {λ}_{2} ) & cos ( {λ}_{3} )\end{matrix} ]$$

where the angles are between connecting line of each satellite and receiver location and x, y, and z axes.

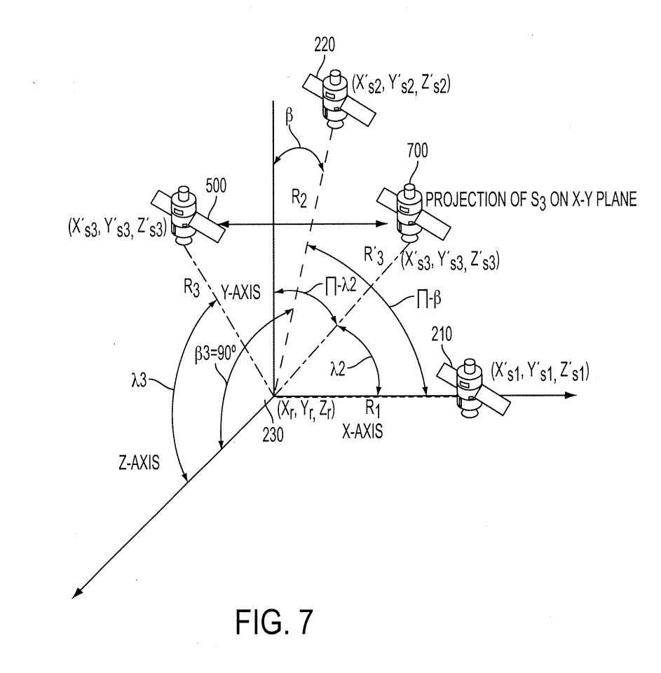

It is possible to rotate the x, y, and z axes such that the x axis falls exactly on the connecting line between the first satellite 210 and the receiver location. Simultaneously, the rotation can be performed such that the connecting line between the second satellite 20 and receiver location 230 falls on the x-y plane. The third satellite, 500, can be anywhere in the 3D space, as illustrated in FIG. 7.

Similar to FIG. 6, FIG. 7 depicts a three satellite embodiment of the present teachings; including a rotated first satellite 210, a rotated second satellite 220, a projected third satellite 500 all located above the receiver location 230. In the new coordinates α₁ which represents the angle between the first satellite and x-axis of the Cartesian coordinates is 0. α₂ and α₃ are both 90 degrees as the rotated satellites lies on the x-axis. Similarly, β₁ and β₂ represents the angle between the rotated second satellite and x-axis and y-axis, respectively. Since the rotated second satellite is on the x-y plane, β₃ is 90 degrees. Similar to the previous case, γ₁, γ₂, and γ₃ represent the angles between the third satellite and x-axis, y-axis, and z-axis, respectively.

In order to use fewer parameters and numbers, one can represent the rotated third satellite with only two angles. In order to proceed, we have to project the rotated third satellite on the x-y plane. The result is the projected rotated third satellite 700. The angle between the rotated satellite and z-axis is referred to as λ₁ and the angle between the projected rotated third satellite and x-axis is λ₁ which give

$$\frac{π}{2} - {λ}_{2}$$

as the angle between the projected rotated third satellite and y-axis.

The rotation changes our G₁ matrix to a second matrix, G₂, a rotated geometry matrix

$$G = [ \begin{matrix}1 & 0 & 0 \\ cos ( β ) & sin ( β ) & 0 \\ cos ( {λ}_{2} ) sin ( {λ}_{1} ) & sin ( {λ}_{2} ) sin ( {λ}_{1} ) & cos ( {λ}_{1} )\end{matrix} ]$$

where the angles are shown in FIG. 7.

Forming the H matrix from the G₂ matrix and its inverse we have;

$$\begin{matrix}H = {G}^{T} \times G = [ \begin{matrix}1 & cos ( β ) & cos ( {λ}_{2} ) sin ( {λ}_{1} ) \\ 0 & sin ( β ) & sin ( {λ}_{2} ) sin ( {λ}_{1} ) \\ 0 & 0 & cos ( {λ}_{1} )\end{matrix} ] \times [ \begin{matrix}1 & 0 & 0 \\ cos ( β ) & sin ( β ) & 0 \\ cos ( {λ}_{2} ) sin ( {λ}_{1} ) & sin ( {λ}_{2} ) sin ( {λ}_{1} ) & cos ( {λ}_{1} )\end{matrix} ] \\ = [ \begin{matrix}1 + {cos}^{2} ( β ) + {cos}^{2} ( {λ}_{2} ) {sin}^{2} ( {λ}_{1} ) & cos ( β ) sin ( β ) + cos ( {λ}_{2} ) sin ( {λ}_{2} ) {sin}^{2} ( {λ}_{1} ) & sin ( {λ}_{1} ) cos ( {λ}_{1} ) cos ( {λ}_{2} ) \\ cos ( β ) sin ( β ) + cos ( {λ}_{2} ) sin ( {λ}_{2} ) {sin}^{2} ( {λ}_{1} ) & {sin}^{2} ( β ) + {sin}^{2} ( {λ}_{1} ) {sin}^{2} ( {λ}_{2} ) & sin ( {λ}_{1} ) cos ( {λ}_{1} ) sin ( {λ}_{2} ) \\ sin ( {λ}_{1} ) cos ( {λ}_{1} ) cos ( {λ}_{2} ) & sin ( {λ}_{1} ) cos ( {λ}_{1} ) sin ( {λ}_{2} ) & {cos}^{2} ( {λ}_{1} )\end{matrix} ]\end{matrix}$$

Given our H matrix, we invert the H matrix to obtain H⁻¹. After inverting the H matrix, we use the diagonal elements of H⁻¹ to obtain the DOP value. In order to simplify the answer trigonometric identities and algebra are used. Simplifying the final DOP answer, DOP_{3c}=\sqrt{H′⁻¹+H′₂⁻¹+H′₃₃⁻¹}, we have

$${DOP}_{3 c} = \sqrt{\frac{2}{{sin}^{2} ( β )} + \frac{1}{{cos}^{2} ( {λ}_{1} )} + \frac{{sin}^{2} ( {λ}_{1} ) [ {sin}^{2} ( {λ}_{2} ) + {sin}^{2} ( {λ}_{2} - β ) ]}{{sin}^{2} ( β ) {cos}^{2} ( {λ}_{1} )}}$$

For saving computational resources, we can ignore the square root sign and merge the entire fraction.

$$D \hat{O} {P}_{3 c} = \frac{2 {cos}^{2} ( {λ}_{1} ) + {sin}^{2} ( β ) + {sin}^{2} ( {λ}_{1} ) [ {sin}^{2} ( {λ}_{2} ) + {sin}^{2} ( {λ}_{2} - β ) ]}{{sin}^{2} ( β ) {cos}^{2} ( {λ}_{1} )}$$

This method is preferred when the angles between the satellites and rotated axes are computed externally and fed to the system. In such cases, it is very easy to find the trigonometric values of the angles and calculate DOP_{3c}. It is computationally more efficient and less time consuming than other methods. The projection of the third satellite on the new x-y plane results in a simpler matrix than the second method and hence finding the DOP_{3c} metric becomes faster. However, if the angles are not provided externally and are to compute in the system, the algorithm is less efficient than either of the previous methods.

The many features and advantages of the embodiments of the present invention are apparent from the detail specification, and thus, it is intended to cover all such features and advantages of the invention that fall within the true spirit and scope of the invention. All suitable modifications and equivalents maybe resorted to, falling within the scope of the invention.

What is claimed is:

1. A method for determining a Dilution of Precision Metric (DOP) with less than four satellites in a hybrid positioning system, the method comprising:
determining an initial position estimate of a device using a non-satellite positioning system;
obtaining satellite measurements from less than four satellites, wherein the measurements include each satellite's position with respect to the initial position estimate;
constructing a geometry matrix corresponding to the measurements from the less than four satellites using each satellite's position and the initial position estimate;
multiplying the geometry matrix by its transpose to construct an H matrix;
determining an inverse of the H matrix; and
determining the DOP based on a sum of the diagonal elements of the inverse H matrix.

2. The method of claim 1 wherein the non-satellite positioning system is a WLAN positioning system.

3. The method of claim 1 comprising obtaining satellite measurements from three satellites.

4. The method of claim 1 comprising selecting a set of satellites based on the value of the DOP.

5. The method of claim 1 comprising selecting a set of satellites to integrate in hybrid positioning system with the non-satellite positioning system if the DOP is small.

6. The method of claim 5, wherein a small DOP corresponds to set of satellites which display good geometry in reference to the location of the mobile device.

7. The method of claim 5, wherein a small value of DOP comprises a value between about 1.4 to about 2.5.

8. The method of 1 comprising not selecting the set of satellites to determine the position the mobile device and reporting the initial position estimate if DOP is large.

9. The method of claim 8, wherein a large DOP corresponds to satellites that are display poor geometry in reference to the position of the mobile device.

10. The method of claim 8, wherein a large value of DOP comprises 3.0.

11. A method for determining value of a Dilution of Precision Metric (DOP) with less than four satellites in a hybrid positioning system, the method comprising:
determining an initial position estimate of a device using a non-satellite positioning system;
obtaining satellite measurements from a set of three satellites, wherein the measurements include each satellite's position with respect to the initial position estimate;
rotating the set of satellites to form a rotated set of satellites having standard coordinates;
determining a rotated geometry matrix using angles between the rotated set of satellites and the set of rotated axes;
multiplying the geometry matrix by a transpose of the rotated geometry matrix to create an H matrix; and
determining a DOP based on the diagonal elements of the inverse of the H matrix.

12. The method of claim 11 wherein the non-satellite positioning system is a WLAN positioning system.

13. The method of claim 11 comprising selecting a set of satellites based on the value of DOP.

14. The method of claim 11 comprising selecting a set of satellites to integrate in the hybrid positioning in order to improve the position estimate if the DOP is small.

15. The method of claim 14, wherein a small DOP corresponds to set of satellites which display good geometry in reference to the location of the mobile device

16. The method of 11 comprising refining the initial position estimate if the DOP is small.

17. The method of claim 16, wherein a small value of DOP comprises a value between about 1.4 to about 2.5.

18. The method of 11 comprising reporting the initial position estimate if the DOP is large.

19. The method of claim 18, wherein a large DOP corresponds to satellites that display poor geometry in reference to the position of the mobile device.

20. The method of claim 19, wherein a large value of DOP comprises 3.0.

21. A method for determining a Dilution of Precision Metric (DOP) with less than four satellites in a hybrid positioning system, the method comprising:
determining an initial position estimate of a device using a non-satellite positioning system;
obtaining satellite measurements from less than four satellites, wherein the measurements include each satellite's position with respect to the initial position estimate; and
determining a DOP based on the initial position estimate and the satellite measurements from less than four satellites.

22. The method of claim 21 wherein the non-satellite positioning system is a WLAN positioning system.

23. The method of claim 21 comprising obtaining satellite measurements from two satellites.

24. The method of claim 23, wherein the DOP is related to the angle between the two satellites with respect to the initial position estimate.

25. The method of claim 21 comprising obtaining satellite measurements from three satellites.

26. The method of claim 21 comprising selecting a set of satellites based on the value of DOP.

27. The method of claim 21 comprising selecting a set of satellites to integrate in the hybrid positioning in order to improve the position estimate if the DOP is small.

28. The method of claim 27, wherein a small DOP corresponds to set of satellites which display good geometry in reference to the location of the mobile device

29. The method of 27 comprising refining the initial position estimate if the DOP is small.

30. The method of claim 27, wherein a small value of DOP comprises a value between about 1.4 to about 2.5.

31. The method of 21 comprising reporting the initial position estimate if the DOP is large.

32. The method of claim 31, wherein a large DOP corresponds to satellites that display poor geometry in reference to the position of the mobile device.

33. The method of claim 31, wherein a large value of DOP comprises 3.0.
